(19) United States
(12) Patent Application Publication
(10) Pub. No.: US 2013/0260356 A1
(43) Pub. Date: Oct. 3, 2013

(54) ELECTRONIC ASSIGNMENT MANAGEMENT SYSTEM FOR ONLINE LEARNING PLATFORM

(71) Applicant: LOUDCLOUD SYSTEMS INC., Dallas, TX (US)

(72) Inventors: Manoj Kutty, Dallas, TX (US); Anil Vishwanath Sonkar, Andheri (IN); Krishnaparag Prakash Kamat, Mumbai (IN)

(73) Assignee: LoudCloud Systems Inc., Dallas, TX (US)

(21) Appl. No.: 13/853,311

(22) Filed: Mar. 29, 2013

Related U.S. Application Data
(60) Provisional application No. 61/618,532, filed on Mar. 30, 2012.

(51) Int. Cl. G09B 7/00

(52) U.S. Cl. CPC G09B 7/00
USPC 434/354

(57) ABSTRACT

Disclosed is a method and system for evaluating performance of at least one first-user on an online platform. A course-builder module enables a second-user to create at least one assignment and to define a set of assessment criteria for assessing the at least one assignment. After creating the at least one assignment, a course-attempting module is configured to enable a first-user to attempt and submit the at least one assignment. Once the at least one assignment is submitted by the first-user, a similarity-check module is configured to apply a similarity-check algorithm on the submitted assignment to automatically generate a report having a score quantifying similarity of the assignment with a content from an online source. Upon applying the similarity-check, a grading module is configured to evaluate the performance of the first-user by assigning a grade to the assignment on the basis of the predefined set of criteria.

### PRIORITY CLAIM

This disclosure claims priority under 35 U.S.C. § 119 to U.S. Provisional Application No. 61/618,532, filed Mar. 30, 2012, and entitled “AN ELECTRONIC ASSIGNMENT MANAGEMENT SYSTEM FOR ONLINE LEARNING TECHNOLOGY.”The aforementioned application is incorporated herein by reference in its entirety.

### TECHNICAL FIELD

The subject matter described herein generally relates to method and system for providing an online assessment. More particularly, the subject matter relates to the method and the system for assessing performance of a user using an online platform.

### BACKGROUND

Rapid evolution of e-learning tools has galvanized the dissemination of knowledge across several kinds of users. The user may be a student, a scholar, a course-seeker, a trainee or any other learner seeking knowledge through an online platform and more particularly, an online learning platform. The online learning platform enables teachers, instructors, mentors or any other online tutor to educate the users remotely in a structured manner. Moreover, it also enables the instructors to evaluate performance of such users connected through the online learning platform using the platform itself

Several assessment methods are applied for evaluating or assessing the performance of the users. One such method is conducting an online assessment test for the users. For conducting such test, instructors have to create assessment test papers or assignment in the form of an electronic content, which is electronically shared with the users. The users in response of the received test papers or the assignments prepare and submit their responses for assessment on the online learning platform. There are several parameters that can be standardized to evaluate the quality of submissions made by the users. One such parameter is to detect plagiarism in the submission made by the users.

Several tools can be used to ensure whether any submission is plagiarized or not, use of such third party tools by the person assessing the submission data is cumbersome and time consuming especially in cases where the volume of data to be assessed is large. The issue of compatibility of the external tools with the format of the data on the e-learning platform presents another layer of challenge to the requirement.

Moreover, the instructors (or any other person assessing the submission data) may also have to follow some set of criteria while reviewing the submitted assignments in order to fairly and evenly evaluate the performance of the users. Again for applying the set of criteria, the instructors are required to identify the available standard criteria, which are generally used for conducting the evaluation of the assignments submitted by the students.

### SUMMARY

This summary is provided to introduce aspects related to systems and methods for evaluating performance of at least one first-user on an online platform and the aspects are further elaborated below in the detailed description. This summary is not intended to identify essential features of the claimed subject matter nor is it intended for use in determining or limiting the scope of the claimed subject matter.

In one implementation, a system for evaluating performance of the at least one user on an online platform is disclosed. The system comprises a processor and a memory coupled to the processor for executing a set of modules stored in the memory. The set of modules comprises a course-builder module, a course-attempting module, a similarity-check module, and a grading module. The course-builder module is configured to enable at least one second-user to create at least one assignment and to define a set of assessment criteria for assessing the at least one assignment. After creating the at least one assignment, the course-attempting module is configured to enable the at least one first-user to attempt and submit the at least one assignment. Upon attempting and submitting the at least one assignment by the at least one first-user, the similarity-check module is configured to apply a similarity-check on the at least one assignment in order to generate a report. The report generated comprises a score quantifying similarity of the at least one assignment with content from an online source. Thereafter, the grading module is configured to evaluate the performance of the at least one first-user by assigning a grade to the at least one assignment on the basis of the set of assessment criteria and the report.

In another implementation, a method for evaluating performance of at least one first-user on an online platform is disclosed. The method comprises multiple steps and one of a step is for enabling at least one second-user to create at least one assignment and to define a set of assessment criteria for assessing the at least one assignment. Upon creating the at least one assignment, step of enabling the at least one first-user to attempt and submit the at least one assignment is performed. Further, after the at least one assignment is attempted and submitted by the at least one first-user, a step is performed for applying a similarity-check algorithm on the at least one assignment in order to generate a report. The report generated comprises a score quantifying similarity of the at least one assignment with a content from an online source. Thereafter, another step is performed for evaluating the performance of the at least one first-user by assigning a grade to the at least one assignment on the basis of the set of assessment criteria and the report generated.

Yet in another implementation, computer program product having embodied thereon a computer program for evaluating performance of at least one first-user on an online platform is disclosed. The computer program product comprises a program code for enabling at least one second-user to create at least one assignment and to define a set of assessment criteria for assessing the at least one assignment. Upon creating the at least one assignment and the set of assessment criteria, a program code is provided for enabling the at least one first-user to attempt and submit the at least one assignment. After the at least one first user attempts and submit the at least one assignment, a program code of the computer program product is provided for applying a similarity-check algorithm on the at least one assignment in order to generate a report. The report generated comprises a score quantifying similarity of the at least one assignment with a content from an online source. Thus, after applying the similarity-check algorithm, a program code is provided for evaluating the performance of the at least one first-user by assigning a grade to the at least one assignment on the basis of the set of assessment criteria and the report.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for evaluating performance of at least one first-user is shown, in accordance with an embodiment of the present subject matter.

FIG. 2 illustrates the system, in accordance with an embodiment of the present subject matter.

FIG. 3 illustrates a detailed working of the system, in accordance with an embodiment of the present subject matter.

FIG. 4 illustrates a method for evaluating performance of at least one first-user on an online platform, in accordance with an embodiment of the present subject matter.

### DETAILED DESCRIPTION

System and method for evaluating performance of at least one first-user on an online platform have been disclosed. The at least one first-user may be a student, a learner, a course-seeker, a trainee, a scholar or any user using the online platform for being evaluated. Hereinafter, “at least one first-user” is referred as “first-user”. On the online platform, a second-user may be enabled for creating at least one assignment and to define a set of assessment criteria for assessing the assignment. The “at least one assignment” hereinafter referred as “assignment”. In one embodiment, at least one second-user may be an administrator, an instructor, a teacher, a mentor, a course-provider or any other user using the online platform for evaluating the performance the first-user. Hereinafter, “at least one second-user” is referred as “second-user”. The assignment may be created on the online platform by providing an online interface to the second-user. Both, the assignment created and the set of assessment criteria defined by the second-user may be stored in a database in the memory of the system. The assignment created may be in a form of subjective-type questions or objective-type questions or a combination thereof. In an embodiment of the disclosure, apart from defining the set of assessment criteria, the second-user may also define a start-date in order to instruct the first-user to start the assignment and end-date for submission of the assignment by the first-user. In another embodiment the second-user may also define the weightages to one or more questions in the assignment.

The second-user may be capable of updating composition and the set of assessment criteria of the assignment even after the creation of the assignment on the online platform. In one embodiment of the disclosure, the first-user may submit the assignment after attempting it on the online platform. In another embodiment of the disclosure, the second-user may have their specific roles. The roles may be defined based on the second-user interacting with the online platform. Depending upon the roles, the system may automatically change graphical user interface (GUI) on the online platform. Based upon the role of the second-user accessing rights may be provided to the second-user. Also, the second-user in the role of the administrator may have the authority to edit, delete, and publish the assignment along with the creation of the assignment.

After attempting the assignment created by the second-user, the first-user may submit the assignment for the second-user's review. The assignment submitted by the first-user may be also stored in the database of the memory of the system. The first-user may attempt the assignment by answering one or more questions provided in the assignment. After answering the one or more questions, the first-user may submit the assignment by uploading it on the online platform. In an alternative scenario, apart from submitting the assignment by uploading it on the online platform, the first-user may also attempt the assignment by writing the answers of the one or more questions over the online platform itself by using an in-line editor. The in-line editor may be an alternative used by the first-user for uploading the assignment after being attempted on the online platform. The assignment, which may be created and/or submitted on the online platform, may be an electronic document in a form of html files, multimedia files including audio, and video.

Upon submitting the assignment by the first-user, a similarity-check algorithm may be applied for generating a report. The report further may comprise a score that may represent the similarity of the assignment with the existing contents available on an online source. The score may be calculated in percentage or in a numerical form. The calculated percentage or the numerical value may represent an amount of material in the assignment submitted by the first-user that matches with available contents. The report may further include a break-down of the online sources from where the material may be copied into the assignment. For applying the similarity-check algorithm, the system may provide a similarity-check module integrated with the online platform.

The similarity-check module may be a third-party tool that is integrated with the online platform. The purpose of integrating the similarity-check module with the online platform may be to automatically perform the similarity-check by the second-user in a single-click action, thus saving the time and energy of the second-user that may be wasted in searching, understanding and in following complex processes for using such third-party tools or the software-as-as-a-services for performing similarity-checks on the assignment submitted by the first-user. Yet, in another embodiment of the disclosure, apart from the second-user the first-user may also apply the similarity-check algorithm before submitting the assignment on the online platform in order to determine the amount of the material in the attempted assignment that may be copied from online sources.

After the report is generated along with the score, a grade may be assigned by the second-user on a basis of the set of assessment criteria that was defined by the second-user at the time of creation of the assignment. Upon assigning the grade to the assignment, the grade may be published along with the report and the score on a grade-book. The grade-book may be an interface on the online platform that may be visible for the first-user and the second-user.

Yet in another embodiment of the disclosure, the system may provide a facility of a peer review, where a group may be created for a group of first-users, wherein the each first-user amongst the group of first-users may assign the grade to each other. Though, the grade may be assigned by the first-user to another first-user of the group of first-users, the rights may be reserved with the second-user to finally decide and assign the actual grade for the first-user. In such kind of group of first-users, a forum may be created wherein each first-user of the group of first-users can inter-communicate with each other over the online platform through the forum. In the scenario, if the assignment submitted by the first-user or by the group of the first-user is not as per the expectation of the second-user, the second-user can reassign the same assignment to the first-user or the group of first-user.

While aspects of described system and method for evaluating performance of a first-user on an online platform may be implemented in any number of different computing systems, environments, and/or configurations, the embodiments are described in the context of the following exemplary system.

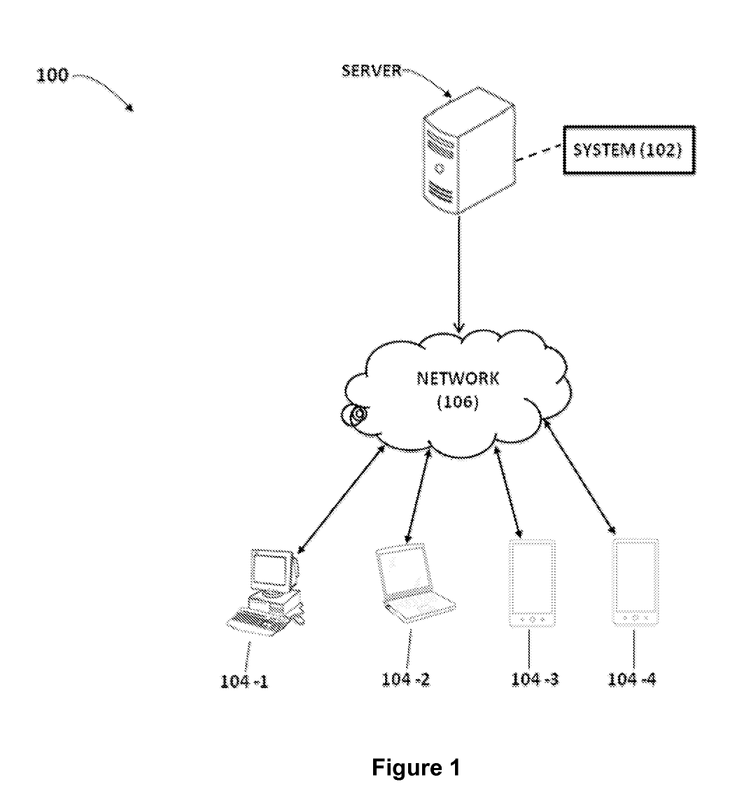

Referring now to FIG. 1, a network implementation 100 of system 102 for evaluating the performance of the first-user is illustrated, in accordance with an embodiment of the present subject matter. In one embodiment, the system 102 may facilitate the evaluation of the performance of the first-user on an online platform.

Although the present subject matter is explained considering that the system 102 is implemented for evaluating the performance of the first-user on a server, it may be understood that the system 102 may also be implemented in a variety of computing systems, such as a laptop computer, a desktop computer, a notebook, a workstation, a mainframe computer, a server, a network server, and the like. The user devices 104 may be communicatively coupled to the system 102 through a network 106. According to the embodiments of the disclosure, the user 104 can be at least one of a first-user or second-user or both. It will be understood that the system 102 may be accessed by the multiple first-users and the multiple second-users through one or more user devices 104-1, 104-2 . . . 104-N. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network may represent an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

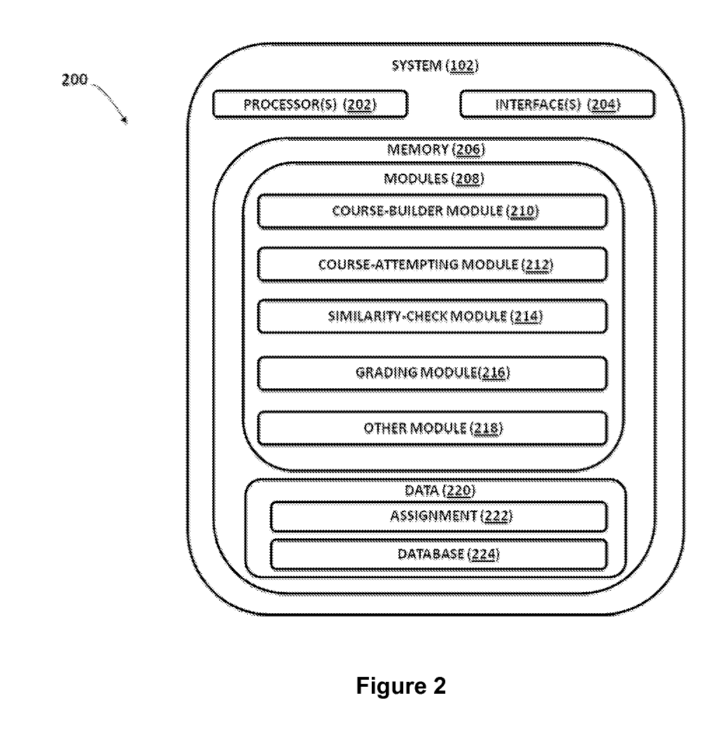

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions or modules stored in the memory 206.

The I/O interface 204 may include a variety of software and hardware interfaces, for example, a web interface, a graphical user interface, and the like. The I/O interface 204 may allow the system 102 to interact with a user i.e., the first-user and/or the second-user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, a compact disks (CDs), digital versatile disc or digital video disc (DVDs) and magnetic tapes or any other storage media. The memory 206 may include modules 208 and data 220.

The modules 208 may include routines, programs, objects, components, data structures, etc., which perform particular tasks or implement particular abstract data types. In one implementation, the modules 208 may include a course-builder module 210, a course-attempting module 212, a similarity-check module 214, a grading module 216 and other modules 218. The other modules 218 may include programs or coded instructions that supplement applications and functions of the system 102.

The data 220, amongst other things, may serve as a repository for storing data processed, received, and generated by one or more of the modules 208. The data 220 may also include at least one assignment 222 and a database 224.

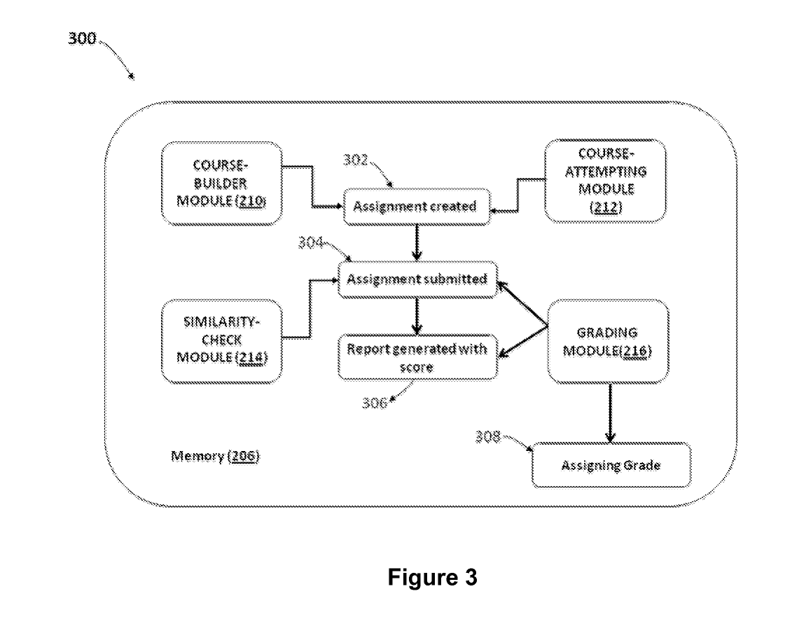

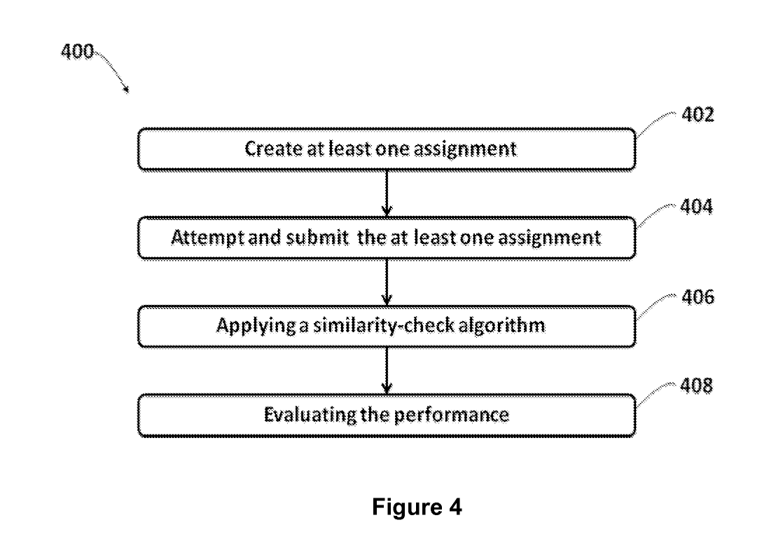

In one implementation, at first, the first-user or the second-user may use the client device 104 to access the system 102 via the I/O interface 204. The first-user and/or the second-user may register them using the I/O interface 204 in order to use the system 102. The working of the system 102 may be explained in detail in FIGS. 3 and 4 explained below. The system 102 may be used for evaluating performance of the first-user on an online platform. The system 102 may provide a bi-directional communication between the first-user and the second-user in order to create, submit and review the assignment. The system may further provide a similarity-check module for applying the similarity-check algorithm on the assignment submitted by the first-user. A report may be generated along with a score when the similarity-check algorithm may be applied upon the assignment submitted by the first-user. The performance of the second-user may be evaluated by assigning a grade on a basis of a predefined set of assessment criteria and the report generated along with the score. Thus, after assigning the grade, the second-user may publishe the grade on a gradebook in order to make it visible for the first-user.

Referring to FIG. 3, a detailed working of the system 102 is illustrated, in accordance with an embodiment of the present subject matter. The system 102 of the present disclosure may comprise of set of modules and one of such module may be a course-builder module 210. The course-builder module 210 may be configured for enabling a second-user to create an assignment and also to define a set of assessment criteria for assessing the assignment. The course-attempting module 212 may be configured to enable a first-user to attempt the assignment created 302 and submit the assignment on an online platform. The assignment created 302 by the second-user and the assignment submitted 304 by the first-user may be stored in a database 224 of the system.

Thereafter, a similarity-check module 214 may be configured to apply a similarity-check algorithm on the assignment submitted 304 by the first-user. After applying the similarity-check algorithm, a report may be generated with a score 306. The score may represent the similarity of the assignment with already existing contents available on an online source. The score may be calculated in percentage or in a numerical form. The calculated percentage or the numerical value may represent an amount of material in the assignment submitted by the first-user matches with previously published or available contents on the online sources. The report may further include a breakdown of the online sources from where the material may be copied into the assignment.

After generating the report along with the score, a grading module 216 may be configured for evaluating the performance of the first-user by assigning a grade 308 to the assignment submitted by the first-user. The grade may be assigned on the basis of the set of criteria and the report. Upon assigning the grade to the assignment, which may be submitted by the first-user, the grade may be published on a grade-book on the online platform. From the grade-book, the first-user can view the grade assigned by the second-user.

Referring now to FIG. 4, the method for evaluating performance of first-user on an online platform is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above-described system 102.

At block 402, second-user may be enabled to create an assignment and define a set of assessment criteria in order to evaluate performance of a first-user. The assignment created and the set of assessment criteria defined may be stored in a database 224 of a memory of the system 102. The assignment may be a subjective type questions or objective-type question or combination thereof. Once the assignment is created by the second-user, the assignment may be assigned to the first-user on an online platform. The online platform may facilitate a bi-directional communication between the first-user and the second-user. With the creation of the assignment, the second-user may also define a start-date and an end-date for the assignment. The start-date may be defined for instructing the first-user to start attempting the assignment created by the second-user. Similarly, the end-date may be defined for instructing the first-user to submit the assignment after attempting it.

At block 404, once the assignment is created by the second-user, the first-user may be enabled to attempt and submit the assignment. The first-user may be enabled for attempting and submitting the assignment assigned by the second-user in two different approaches. In one of such approach, the first-user may be enabled to submit the assignment by uploading it on the online platform of the system 102 after answering one or more questions of the assignment. Whereas in another approach, the first-user may be enabled for writing the one or more answers while attempting the assignment assigned to him/her on the online platform itself by using an in-line editor. After writing the one or more answers to the assignment, the assignment may be submitted on the online platform.

At block 406, after the assignment is submitted on the online platform, a similarity-check algorithm may be applied on the assignment. By applying the similarity-check algorithm, a report may be automatically generated. The report further comprises of a score that may be calculated in a percentage or in a numerical form. The calculated percentage or the numerical value may represent the amount of material in the assignment submitted by the first-user that matches with previously published or available contents from the online sources. The score may provide a fair overview to the second-user about the original work done by the first-user while attempting the assignment and the amount of material copied from online sources. The report may further include a break-down of the online sources from where the material of the assignment is copied into the assignment by the first-user.

At block 408, after the similarity-check algorithm may be applied on the submitted the assignment and the report get generated along with the score, the performance of the first-user may be evaluated. Based upon the predefined set of criteria and the report, a grade may be assigned to the assignment. The grade assigned may represent the performance of the first-user who has attempted and submitted the assignment on the online platform. After assigning the grade to the assignment, it may be published on the grade-book in order to make the grade visible for the first-user.

Exemplary embodiments discussed above may provide certain advantages. Though not required to practice aspects of the disclosure, these advantages may include those provided by the following features:

1. Similarity-check algorithm upon the assignment submitted by the first-user over the online platform itself.

2. Peer-review facility for enabling each first-user from a group of first-users to evaluate each other by assigning a grade.

3. In-line editor for enabling the first-user to attempt and submit the assignment assigned by the second-user on the online platform itself

Although implementations for methods and systems for evaluating the performance of the first-user on the online platform have been described in language specific to structural features and/or methods, it is to be understood that the appended claims are not necessarily limited to the specific features or methods described. Rather, the specific features and methods are disclosed as examples of implementations for evaluating the first-user's performance by providing a single-platform to both first-user and the second-user.

It is intended that the disclosure and examples above be considered as exemplary only, with a true scope and spirit of disclosed embodiments being indicated by the following claims.

I/we claim:

1. A method for evaluating performance of at least one first-user on an online platform, the method comprising:
enabling at least one second-user to create at least one assignment and to define a set of assessment criteria for assessing the at least one assignment;
enabling the at least one first-user to attempt and submit the at least one assignment;
applying a similarity-check algorithm on the at least one assignment in order to generate a report, wherein the report comprises a score quantifying similarity of the at least one assignment with a content from an online source; and
evaluating the performance of the at least one first-user by assigning a grade to the at least one assignment on the basis of the set of assessment criteria and the report, wherein the enabling the at least one second-user, the enabling the at least one first-user, the applying and the evaluating are performed by a processor.

2. The method of claim 1, wherein the at least one first-user may be a student, a learner, a course-seeker, a trainee, a scholar or any user using the online platform for being evaluated.

3. The method of claim 1, wherein the at least one second-user may be an administrator, an instructor, a teacher, a mentor, a course-provider or any other user using the online platform for evaluating the performance the first-user.

4. The method of claim 1, wherein the set of assessment criteria includes content quality and language type.

5. The method of claim 1, wherein the similarity-check algorithm is applied using a similarity-check module integrated with the online platform over a network.

6. The method of claim 1, wherein the at least one assignment may be submitted by a group of first-users connected on the online platform.

7. The method of claim 6, wherein at least one user from the group of first-users may grade the at least one assignment.

8. The method of claim 7, wherein the grade can be validated by the at least one second user.

9. A system for evaluating performance of at least one first-user on an online platform, the system comprising:
a processor; and
a memory coupled to the processor, the memory comprising a plurality of modules capable of being executed by the processor, wherein the plurality of modules comprises:
a course-builder module configured to enable at least one second-user to create at least one assignment and to define a set of assessment criteria for assessing the at least one assignment;
a course-attempting module configured to enable the at least one first-user to attempt and submit the at least one assignment;
a similarity-check module configured to apply a similarity-check on the at least one assignment in order to generate a report, wherein the report comprises a score quantifying similarity of the at least one assignment with a content from an online source; and
a grading module configured to evaluate the performance of the at least one first-user by assigning a grade to the at least one assignment on the basis of the set of assessment criteria and the report.

10. The system of claim 9, wherein the similarity check module may be an external module integrated with the online platform over a network.

11. A computer program product having embodied thereon a computer program for evaluating performance of at least one first-user on an online platform, the computer program product comprising:
a program code for enabling at least one second-user to create at least one assignment and to define a set of assessment criteria for assessing the at least one assignment;
a program code for enabling the at least one first-user to attempt and submit the at least one assignment;
a program code for applying a similarity-check algorithm on the at least one assignment in order to generate a report, wherein the report comprises a score quantifying similarity of the at least one assignment with a content from an online source; and
a program code for evaluating the performance of the at least one first-user by assigning a grade to the at least one assignment on the basis of the set of assessment criteria and the report.
